(19) United States
(12) Patent Application Publication
(10) Pub. No.: US 2025/0197608 A1
(43) Pub. Date: Jun. 19, 2025

(54) XYLAN BASED FILMS AND METHODS FOR MAKING SAME

(71) Applicant: THE UNIVERSITY OF BRITISH COLUMBIA, Vancouver (CA)

(72) Inventors: Scott RENNECKAR, Vancouver (CA); Amanda Marie JOHNSON, Victoria (CA)

(21) Appl. No.: 18/969,767

(22) Filed: Dec. 5, 2024

Related U.S. Application Data
(60) Provisional application No. 63/610,548, filed on Dec. 15, 2023.

(51) Int. Cl. C08L 5/00; C08K 5/053; C08L 1/02

(52) U.S. Cl. CPC C08L 5/00; C08K 5/053; C08L 1/02

(57) ABSTRACT

Films comprising xylan from plant based material and microfibrillated cellulose have example application to packaging. The xylan has a molecular weight of at least 22 kDa. The films contain little or no lignin. A method for making films comprises extracting xylan that has a molecular weight of at least 22 kDa from plant based material such as esparto grass, mixing the extracted xylan with microfibrillated cellulose in a solution; and forming a layer of the solution on a surface and drying the solution to form the film. A water content of the extracted xylan is maintained at 50% or more from extraction of the xylan to mixing the xylan with the microfibrillated cellulose in suspension.

### CROSS-REFERENCE TO RELATED APPLICATION

This application claims the benefit under 35 U.S.C. § 119 of U.S. application No. 63/610,548 filed 15 Dec. 2023 and entitled XYLAN BASED FILMS AND METHODS FOR MAKING SAME which is hereby incorporated herein by reference for all purposes.

### FIELD

The present invention relates to bio-based films. The films have example applications as packaging materials.

### BACKGROUND

Plastics are ubiquitous in modern life. For example, plastics are found in textiles, consumer goods, construction materials, and packaging. Packaging consumes about 40% of manufactured plastics. While plastics exhibit outstanding material properties and can be produced at a low cost, plastics can harm the environment.

Most plastics in current production are sourced from petroleum. Unlike most other materials synthesized by living organisms petroleum-based plastics do not biodegrade well. Rather, synthetic plastics persist in the environment and can do significant harm to organisms and ecosystems.

With the move towards sustainable and renewable materials, recent years have seen a rapid increase in the production of bio-based polymers. Even though bio-based polymers are sourced from plants many bio-based polymers are not biodegradable. Bio-based polyethylene, for example, has the same molecular structure as conventional polyethylene but originates from sugar-derived ethanol.

There is a need for sustainable replacements for petroleum based plastics. There is a particular need for such materials that are renewable, biodegradable and have desirable properties for use in packaging.

### SUMMARY

The present invention provides bio-based films and methods for making bio based films. The films have example applications as materials for packaging items such as food items.

One aspect of the invention provides a method for making a film. The method comprises extracting xylan having a molecular weight of at least 22 kDa, from plant based material. The extracted xylan has a lignin content not exceeding 3% by weight (e.g. a content in the range of 0% to 3% by weight). The method comprises mixing the extracted xylan with microfibrillated cellulose in a solution and subsequently forming a layer of the solution on a surface and drying the solution to form the film on the surface. Between extracting the xylan and mixing the extracted xylan with the microfibrillated cellulose in the solution, a solvent content of the extracted xylan is maintained to be at least 50% by weight.

In some embodiments, between extracting the xylan and mixing the extracted xylan with the microfibrillated cellulose in the solution, the extracted xylan has a water content of at least 80% by weight.

In some embodiments, upon extraction the extracted xylan has a water content of at least 80% by weight.

In some embodiments the method comprises, between extracting the xylan and mixing the extracted xylan with the microfibrillated cellulose in the solution, holding the solution at a temperature in the range of at least 60 C to 90 C for a period of at least 30 minutes.

In some embodiments, a weight ratio of the extracted xylan to the microfibrillated cellulose is approximately 2:1.

In some embodiments, a content of glucuronic acid in the xylan does not exceed 7% on a dry weight basis.

In some embodiments, all or a majority of the plant based material is esparto grass. In some embodiments the esparto grass is of the species Stipa tenacissima, L.

In some embodiments the solution is a water solution.

In some embodiments, mixing the xylan with the microfibrillated cellulose in the solution comprises forming a suspension of the xylan in the solution wherein the suspension has a solids content in the range of about 1% to 3% by weight.

In some embodiments, the method comprises providing a plasticizer in the solution. In some embodiments the plasticizer comprises sorbitol. In some embodiments, a weight ratio of the extracted xylan to the microfibrillated cellulose to the plasticizer is approximately 6:3:1.

In some embodiments the microfibrillated cellulose comprises fibers having a mean width of approximately 20 μm. In some embodiments the microfibrillated cellulose comprises fibers having a ratio of mean length to mean width of at least 40. In some embodiments the microfibrillated cellulose comprises fibers having a mean length of approximately 1 mm.

In some embodiments the film has a tensile strength of at least 60 MPa.

In some embodiments the film is translucent or transparent.

In some embodiments the film is biodegradable.

Another aspect of the invention provides films. The films comprise xylan from plant based material. The xylan has a molecular weight of at least 22 kDa, The xylan has little to no lignin content (e.g. a lignin content in the range of 0% to 3% by weight). The film also comprises microfibrillated cellulose. The microfibrillated cellulose may be non-covalently bonded to the xylan in the film.

In some embodiments the film comprises a plasticizer. The plasticizer may comprise sorbitol. In some embodiments a weight ratio of the xylan to the microfibrillated cellulose to the plasticizer in the film is approximately 6:3:1.

In some embodiments the Dylan in the film is esparto xylan (i.e. xylan extracted from esparto grass. In some embodiments the esparto grass is of the species Stipa tenacissima, L.

In some embodiments, the film has a tensile strength of at least 60 MPa.

In some embodiments the film is transparent.

In some embodiments the film is white in colour.

In some embodiments the film has a thickness in the range of 20 μm to 100 μm.

In some embodiments the film has a water vapour permeability not exceeding 500 g/m²·24 h.

Another aspect of the invention provides a film having any new and inventive feature, combination of features, or sub-combination of features as described herein.

Another aspect of the invention provides methods having any new and inventive steps, acts, combination of steps and/or acts or sub-combination of steps and/or acts as described herein.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a flowchart that illustrates a method according to an example embodiment.

FIG. 1A is a graph showing comparative X-ray diffraction patterns for extracted xylan having different water contents.

FIG. 2 is a s a plot showing gel-permeation chromatographic traces for untreated and delignified esparto xylan dissolved in DMSO.

FIG. 3A is a plot showing N₂ adsorption-desorption isotherms for delignified and untreated films. FIG. 3B is a plot of pore size distribution curves of the treated and untreated films.

FIG. 4 is a plot that shows stress—strain relationships for various films.

FIG. 5A is a set of curves that show total cumulative CO₂ production for the samples of different films. FIG. 5B shows % degradation as a function of time for the films of FIG. 5A.

FIG. 6A is a set of curves that show the mass of CO₂ produced by microbial populations as samples of test films were metabolized. FIG. 6B is a set of curves that show % biodegradation of samples of different films as a function of time.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Methods for Making Bio-Based Films

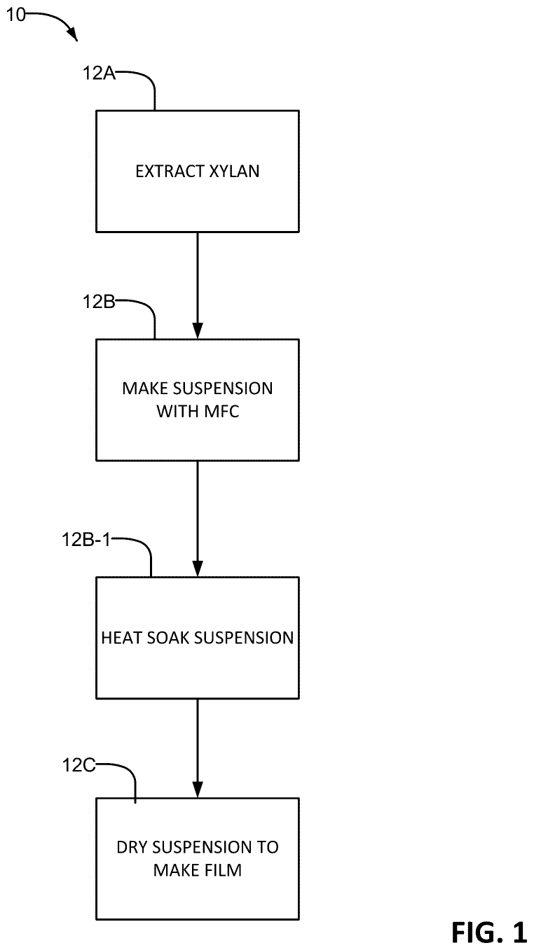

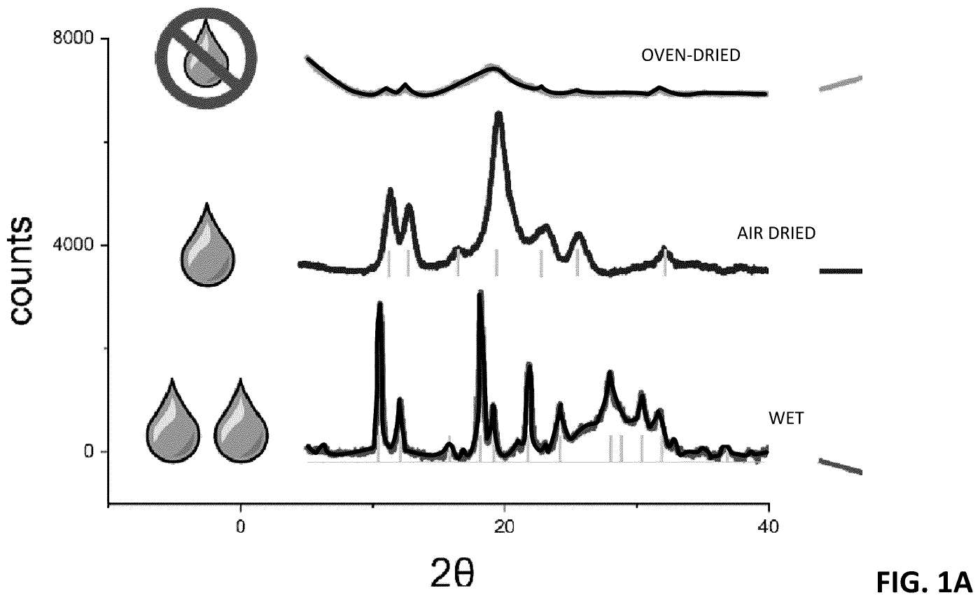

FIG. 1 is a flowchart that illustrates a method 10 for making a bio-based film according to an example embodiment of the invention. In block 12A, xylan is extracted from plant based material. The xylan has a molecular weight of at least 22 kDa. Upon extraction the extracted xylan typically has a solvent content of at least 80% by weight and a lignin content not exceeding 3% by weight (i.e. a lignin content in the range of 0% to 3% by weight). In some embodiments the solvent is water.

In some embodiments the extracted xylan has the form of a smooth paste. In some embodiments the past is white or off white in colour.

In some embodiments the content of glucuronic acid in the xylan does not exceed about 7% on a dry weight basis (i.e. is in the range of 0% to 7%).

In some embodiments the plant based material comprises a grass. In some embodiments the grass is Esparto grass. In some embodiments, all or a majority of the plant based material is Esparto grass. In some embodiments all or a majority of the plant based material consists essentially of Esparto grass of the species Stipa tenacissima, L.

In block 12B the extracted xylan is mixed with microfibrillated cellulose (“MFC”) in a solution. In some embodiments a weight ratio of the extracted xylan to the MFC is approximately 2:1.

In some embodiments nanocellulose is included in the solution. In such embodiments the weight ratio of the extracted xylan to the combined MFC and nanocellulose may be approximately 2:1.

In some embodiments block 12B comprises forming a suspension of the xylan in the solution in an amount such that the suspension has a solids content in the range of about 1% to 3% by weight.

In some embodiments the solution includes a solvent that comprises or consists essentially of or consists of water.

Between the time that the xylan is extracted in block 12A and the time that the xylan is mixed with the MFC in the solution in block 12B the solution content (e.g. the water content) of the extracted xylan is maintained to be at least about 50% by weight. Maintaining the water content to be at least about 50% may inhibit or reduce crystallization of the xylan. This, in turn, may help to reduce brittleness of the produced film. The extracted xylan has a water content high enough that the xylan has a dihydrate form. Presence of the dihydrate form of xylan may be verified by x-ray crystallography. FIG. 1A shows that the X-ray crystallographic pattern of xylan that has a water content exceeding 50% by weight (and has the dehydrate form) is different from that of air-dried xylan which has a water content in the range of about 8% to 10% (and has the hydrate form).

Maintaining the water content of the extracted xylan at levels of 75% or more or 80% or more at the time the extracted xylan is mixed into the solution in block 12B more can beneficially make the extracted xylan easier to work with and to mix into the solution. Additionally maintaining a water content of 75% or more can help to prevent drying of portions of a body of extracted xylan to moisture levels low enough to facilitate crystallization of the extracted xylan.

In some embodiments the extracted xylan has the dihydrate form at the start of block 12B.

In block 12C a film is cast by forming a layer of the solution on a surface and drying the solution to form the film on the surface.

In some embodiments the method includes optional block 12B-1 in which the solution containing the xylan and the MFC is maintained at an elevated temperature of at least 60° C. or 70° C. for a period of at least 30 minutes prior to drying the solution in block 12C. For example, the solution may be held at a temperature in the range of about 60° C. or 70° C. to 90° C. for such a period. Block 12B-1 may, for example be performed while the solution is on the surface on which the solution is cast in block 12C or in a separate vessel.

While the inventors do not wish to be bound by any particular theory of operation it is thought that holding the solution containing the xylan and the MFC at an elevated temperature (e.g. a temperature of at least 50° C.) for a period of time prior to drying the solution facilitates bonding of the xylan to the MFC which may improve physical properties of the resulting film.

In some embodiments a plasticizer is included in the solution. The plasticizer may, for example, be added to the solution in block 12B. The plasticizer may, for example, comprise sorbitol glycerol, or xylitol. In some embodiments the weight ratio of the extracted xylan to the MFC to the plasticizer is approximately 6:3:1. For example, the weight ratio may be 6 parts xylan from Esparto grass; 3 parts MFC and 1 part sorbitol.

In some embodiments the MFC has a mean length of about 1 mm and a mean width of less than 0.04 mm (e.g. about 0.02 mm). In some embodiments the MFC has a fine percentage of about 15% w/w. In some embodiments the MFC has a curl index LW of about 0.05 mm. In some embodiments the MFC has a kink index of about 1 mm⁻¹.

### Bio-Based Films

Another aspect of the present invention provides a film comprising xylan sourced from plant based material. The xylan in the film is bonded to MFC by non-covalent interactions. The xylan has a molecular weight of at least 22 kDa. The film has a lignin content of 0% to 3% by weight.

In some embodiments the content of glucuronic acid in the xylan does not exceed 7% on a dry weight basis (i.e. is in the range of 0% to 7%).

In some embodiments the xylan is a homoxylan. Homoxylans are characterized by a backbone of D-xylopyranose residues linked by β(1→4) glycosidic linkages. In some embodiments the xylan is extracted from a grass. In some embodiments the grass is Esparto grass. In some embodiments, all or a majority of the xylan is xylan extracted from Esparto grass. In some embodiments all or a majority of the xylan is xylan extracted from Esparto grass of the species Stipa tenacissima, L.

In some embodiments the film comprises a plasticizer. For example, the plasticizer may be sorbitol glycerol, or xylitol. In some embodiments the weight ratio of the xylan to the MFC to the plasticizer in the film is approximately 6:3:1.

In some embodiments the film has a thickness in the range of 20 to 200 μm.

In some embodiments the film has a tensile strength of at least 60 MPa.

In some embodiments the film has a water vapour transmission rate not exceeding 645 g/m2 per day. The water vapour transmission rate may, for example, be measured according to ASTM E96-15.

In some embodiments the film is translucent or transparent. In some embodiments the film is clear. A clear film may, for example be used to make a window in packaging or to make packaging which allows contents of a package to be viewed through the window or packaging. In some embodiments the film is white or off white in colour.

In some embodiments the film is biodegradable. The film may be biodegradable in both compost and seawater.

### Examples

The following sections provide example ways to prepare and characterize featured of films as described herein. Methods for making films according to the invention may include features mentioned in the following examples. Films according to the invention may have properties and/or features as described in any of the following examples.

### Preparation of Plant Based Material

Xylan was extracted from Esparto grass (Stipa tenacissima, L.). The Esparto grass originated from southern Spain. The Esparto grass was ground to 20-mesh using a Wiley™ mill. Extractives were removed using a Soxhelet™ extractor containing a solvent mixture of 1:2 ethanol:toluene v/v. The Esparto grass was then air-dried.

### Lignin Removal

Lignin was removed from the Esparto grass by acid-chlorite bleaching. The bleaching was performed according to Pulp and Paper Technical Association of Canada (PAPTAC) Chlorite Delignification of Cellulosic Materials (1998). Sodium chlorite was added to 1% w/v aqueous acetic acid to make a 0.55 M solution. Esparto grass was added at a solids ratio of 10% w/v and stirred in the dark for 24 hours. The bleached material was washed with 6 volumes of distilled water, resuspended in 16 volumes of water and stirred for 10 minutes. Bleached material was filtered and air-dried to yield Esparto pulp prior to alkali extraction.

For alkali extraction, Esparto pulp was suspended in 1.0 M sodium hydroxide at a 5% solids content in a N₂ environment with stirring for 18 hours. The suspension was filtered, and xylan was precipitated from the filtrate following neutralization to pH 5 with acetic acid and addition of 0.2 volumes methanol.

### Xylan Separation

Xylan was separated by centrifugation and the resulting pellet was washed with 20 volumes of methanol. Water was added and methanol was evaporated until the xylan paste comprised 10% washed alkali extractives and 90% water by weight. The resulting xylan had the form of a white paste.

### Measurement of Lignin Content

Lignin content of untreated xylan and delignified xylan was determined by the Klason method according to TAPPI Standard Method T 222 m-43. Unbleached xylan had a lignin content of 15.4% w/w and bleached xylan had a lignin content of 2.9% w/w.

### Quantification of Neutral and Sugar-Acid Residues

### Method

To quantify the neutral and acid-sugar residues constituting the xylan samples, the xylan samples were hydrolyzed, derivatized, and subjected to UHPLC analysis using the approach described in Sakamoto, S., Yoshida, K., Sugihara, S., & Mitsuda, N., Development of a new high-throughput method to determine the composition of ten monosaccharides including 4-O-methyl glucuronic acid from plant cell walls using ultra-performance liquid chromatography Plant Biotechnology, 32(1), (2015). https://doi.org/10.5511/plantbiotechnology.15.0113a.

Using this approach, 2 mg of xylan (dry weight) was added to 500 μL of 2 M trifluoroacetic acid in a screw-cap plastic vial. Following 60 minutes of hydrolysis at 121° C. and 100 kPa, a 20-μL aliquot was mixed with 80 μL derivatizing reagent containing 100 mg/mL benzocaine, 117 μL/mL glacial acetic acid, and 10 mg/mL sodium cyanoborohydride in methanol. 3-O-methylglucose was used as an internal standard. The reaction was incubated at 60° C. for 60 minutes and then cooled to 4° C.

After passing through a polyvinylidene difluoride filter with a 0.45-μm pore size, derivatized sugars were detected using UHPLC with diode array detection (1290 Infinity II™ UHPLC system, Agilent Technologies Inc., Santa Clara, California, U.S.A.). 1 μL of benzocaine-derived hydrolysate was injected onto an AQUITY™ BEH C18 column (100 mm×2.1 mm, 1.7-μm particle size, Waters Inc., Milford, Massachusetts, U.S.A.). The flow rate was 0.5 mL/min and a gradient of 5 to 12% acetonitrile in 200 mM borate buffer (pH 8.9) over 10 minutes was employed.

By this method, six neutral sugars (arabinose, rhamnose, galactose, glucose, xylose, and mannose) and three uronic acids (glucuronic acid, 4-O-methylglucuronic acid, and galacturonic acid) could be resolved and detected at a wavelength of 308 nm. Between samples, the column was cleaned with 90% acetonitrile in 200 mM borate buffer (pH 8.9). Sugar standards of known concentration were subjected to the same hydrolysis treatment and derivatization to allow for quantification of the sugars while correcting for sugar degradation. Three technical replicates were analyzed for each xylan preparation.

### Results

Samples of xylan from both untreated and acid chlorite delignified esparto grass were analyzed for sugar and uronic acid composition, as well as lignin content. The results of the analysis are shown in Table 2:

TABLE 2
Neutral sugar, acid sugar, and lignin composition (%) of xylans

| Constituent | Untreated | Delignified |
|---|---|---|
| Xylose | 54.61 ± 1.47 | 73.46 ± 2.21 |
| Glucuronic acid | 2.16 ± 0.87 | 3.64 ± 0.62 |
| 4-O-Methyl glucuronic acid | 2.15 ± 0.15 | 2.54 ± 0.17 |
| Galacturonic acid | 0.64 ± 0.02 | 0.83 ± 0.13 |
| Rhamnose | 0.21 ± 0.02 | 0.59 ± 0.08 |
| Galactose | 0.70 ± 0.03 | 0.61 ± 0.02 |
| Glucose | 4.99 ± 0.16 | 4.02 ± 0.10 |
| Arabinose | 8.98 ± 0.30 | 9.79 ± 0.32 |
| Fucose | nd | nd |
| Mannose | 0.04 ± 0.00 | nd |
| Lignin | 15.45 ± 0.691 | 2.90 ± 0.291 |
| Totals | 89.93 | 98.34 |

Xylose was the major component of both acid chlorite-treated and untreated esparto grass xylan. Both esparto xylans contained significant amounts of arabinose, likely from pectic arabinans, which co-extract with xylan from alkali.

The arabinose content in delignified esparto xylan may be reduced or substantially eliminated by precipitating the delignified esparto xylan with a chelating agent.

The acid chlorite treatment significantly reduced acid-insoluble lignin in the alkali extractives. Other neutral and acid sugars were also present in small amounts. Acid-soluble lignin may account for some of the remaining mass balance of esparto untreated xylan.

Acetyl groups are abundant side groups on xylan but are saponified during alkali extraction.

### Determination of Xylan Molecular Weight

The molecular weight distribution of the xylan was evaluated by gel permeation chromatography (GPC) according to the protocol described in Ji, L., Liu, L. Y., Cho, M., Karaaslan, M. A., & Renneckar, S. Revisiting Mass and Conformation of Derivatized Fractionated Softwood Kraft Lignin, Biomacromolecules, 23(3), (2022). https://doi.org/10.1021/acs.biomac.1c01101. Using this protocol, 10 mg of xylan was dissolved in 1 mL DMSO/LiBr mixture (95/5% v/v). The xylan solution was dissolved at room temperature for 48 hours before being passed through a 0.45-micron PTFE filter. Samples were then analyzed with an Agilent 1100™ multidetector size exclusion chromatography system fitted with Styragel™ HR1, HR3, and HR4 columns, connected in series (Waters Corp., USA).

Detection was performed using differential refractive index (Optilab T-rEX™ Wyatt Corp., Santa Barbara, USA) and light-scattering detectors at 785 nm (DAWN HELEOS-II™, Wyatt Corp., Santa Barbara, USA) and 35° C. The eluent was DMSO made to 0.5% w/w with LiBr at a flow rate of 0.5 mL/min. The data were collected using ASTRA™ 6.0 light-scattering software (Wyatt, Santa Barbara, USA) and analyzed by conventional calibration methods to obtain the relative molar mass. A standard curve of low molecular weight polystyrene standards ranging in average molecular weight from 1 400 to 110 000 g/mol (Millipore Sigma) was constructed, allowing for normalization of the 90° detector and calibration of light-scattering equipment.

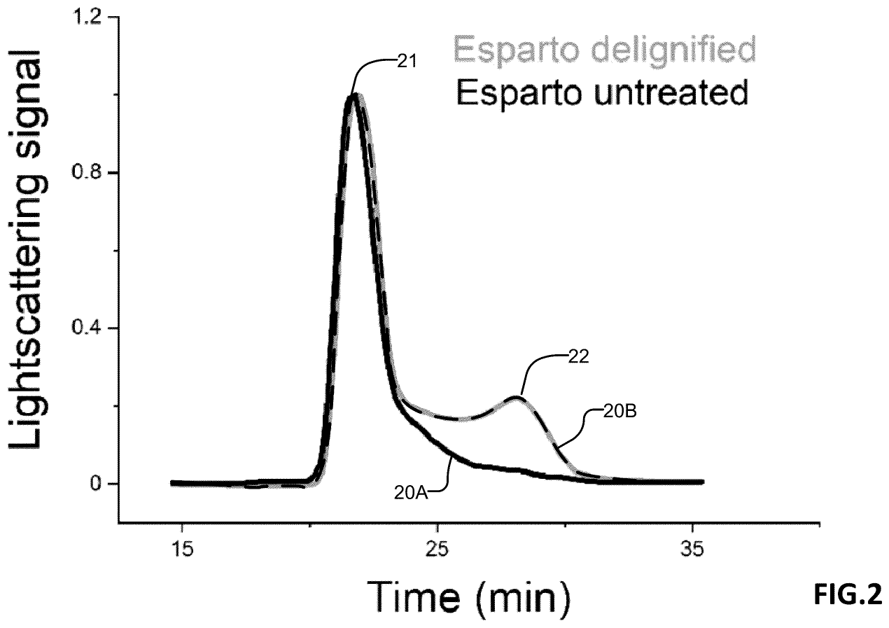

FIG. 2 is a plot showing gel-permeation chromatographic traces of light-scattering signal from untreated (trace 20A) and delignified (trace 20B) esparto xylans dissolved in DMSO. Delignified esparto xylan had a number-average molecular weight of 22.1±1.0 kDa corresponding to a degree of polymerization of 147. The GPC trace 20B of delignified esparto xylan revealed a predominant peak 21 eluting at 22 minutes and a minor peak 22 eluting at 28 minutes. By contrast, GPC analysis of untreated esparto xylan had only one predominant peak corresponding to the same molecular weight as the delignified sample.

Peak 22 likely corresponds to a population of smaller xylan chains produced in the delignification step, for example by access to other xylan within the cell wall facilitated by cleavage of xylan-lignin co-polymers.

### Preparation and Characterization of Microfibrillated Cellulose (MFC)

Northern bleached softwood Kraft pulp made from lodgepole pine (Pinus contorta, 70%), white spruce (Picea glauca, 25%) and subalpine fir (Abies lasiocarpa, 5%) was obtained from Canfor Pulp Products Inc. Intercontinental Pulp Mill (Prince George, Canada). The pulp was subjected to low consistency refining at the Pulp and Paper Centre at the University of British Columbia (Canada) as described in Salim, S., & Olson, J., On the net refining energy and tensile development of NBSK pulp in a low consistency refiner. Nordic Pulp & Paper Research Journal, 32(1), 110-118, (2017). https://doi.org/10.3183/npprj-2017-32-01-p110-118

Refining conditions are shown in the following Table 1.

TABLE 1
NBSK pulp refining conditions

| Energy input | 1874.8 | kWh/t |
|---|---|---|
| Consistency | 1.59% | |
| Refiner speed | 1200 | rpm |
| Flow rate | 250 | L/min |
| Bar edge length | 12.9 | km/rev |
| Specific edge load | 0.05 | J/m |

The resulting MFC was analyzed using a HiRes Fibre Quality Analyzer manufactured by OpTest Equipment Inc. (Hawkesbury, Ontario, Canada). Fine percentage was defined as the percentage of fines between 0.07 mm and 0.20 mm in length. Mean fibre length and width was determined using light polarizing optics. The MFC was imaged using scanning electron microscopy.

Low consistency refining resulted in overall reduction in fibre length compared to the starting NBSK pulp. Mechanically beating pulps causes the bulk fibre structure to disintegrate into long strands or ribbons of microfibrils and these can entangle and gelatinize. Microfibrillation of fibres by low consistency refining resulted in an improved fibre-network, superior bonding among strands, and higher tear resistance compared to non-refined NBSK pulp.

Table 3 shows properties of the MFC used in these examples:

TABLE 3
MFC properties

| | | |
|---|---|---|
| Fine Percentage | 15.08% | w/w |
| Length | 0.939 | mm |
| Curl index LW | 0.052 | mm |
| Kink index | 0.973 | 1/mm |
| Mean width | 19.40 | μm |

SEM micrographs of the MFC show a high degree of fibrillation.

### Formation of Films

Xylan-based films were prepared from the alkali extractives of esparto grass that were either untreated or delignified by acid chlorite treatment as described herein. Films prepared from untreated esparto grass were noticeably brown in colour.

Films prepared from delignified esparto grass (“delignified films”) contained xylan, MFC, and sorbitol in a ratio of 6-3-1 by weight (at 50% relative humidity the films also have a water content of about 9% by weight). Films prepared from untreated esparto grass (“untreated films”) contained xylan, MFC, sorbitol and co-precipitated lignin in a ratio of 51-30-10-9 by weight. Control films (“MFC films”) were made of pure MFC.

Water was added to a final solids content of 1% and the suspension was stirred at 300 rpm with an electric overhead stirrer for 20 minutes at room temperature. The mixture was sonicated in a high-intensity ultrasonic bath for 20 minutes to remove dissolved gases. The solution was further stirred under vacuum for 20 minutes to remove dissolved gases.

The suspensions were cast into a glass tray and dried at 50° C. overnight. The dried films were equilibrated to 50% relative humidity and 23° C. and for 48 hours.

The delignified films were translucent, possessed mechanical integrity and were slightly off-white. The delignified films were visually appealing without noticeable defects and possessed suitable mechanical properties to make folded bags as well as cut-out windows in dry goods packaging.

The untreated films were yellow-brown in colour and could be folded into bakery bags.

### Characterization of Films

### Microstructure

Film ultrastructure was examined using scanning electron microscopy (SEM). Films were immersed in liquid nitrogen, freeze-fractured and mounted on a carbon-taped SEM stub. Prior to SEM analysis, the samples were coated with a 5-nm layer of iridium at 2.7 mPa using a Leica EM MED 020™ sputter coater. SEM analysis was performed using a FEI Helios Nanolab 650™ operating at a 1 kV accelerating voltage.

The SEM studies showed that the ultrastructure of the delignified and untreated films was similar. The surface of the delignified films and the untreated films was relatively smooth with some masked fibrillar texture. In cross section, the films appear stratified with some porosity.

The SEM analysis showed the surface of the MFC control film to be rougher than that of the xylan-based films with the fibrillar texture more pronounced, especially under higher magnification. In cross-sectional micrographs, the MFC film appears stratified with larger voids than the xylan-based films. In cross-sectional micrographs the MFC film appears stratified with larger voids than the xylan-based films.

### Pore Volume, Surface Area and Pore Size Distribution

The pore volume, surface area and pore size distributions of delignified films and untreated films were determined from nitrogen (N₂, 77° K) adsorption-desorption isotherms using a Micromeritics 3Flex™ physisorption analyzer. Samples were degassed under vacuum at 80° C. for 16 h prior to gas sorption experiments. The total pore volume (Vₜₒₜₐₗ) was obtained from the nitrogen adsorption isotherm at p/p0˜0.99 and the specific surface area (S_{BET}) was determined using a modified version of the Brunauer-Emmett-Teller (BET) method as described in Brunauer, S., Emmett, P. H., & Teller, E., Adsorption of Gases in Multimolecular Layers, Journal of the American Chemical Society, 60(2), (1938) https://doi.org/10.1021/ja01269a023. The micropore volume (V_{micro}) was calculated using t-plot analysis as described in Scherdel, C., Reichenauer, G., & Wiener, M., Relationship between pore volumes and surface areas derived from the evaluation of N₂-sorption data by DR-, BET-and t-plot. In Microporous and Mesoporous Materials (Vol. 132, Issue 3), (2010), https://doi.org/10.1016/j.micromeso.2010.03.034.

The pore size distributions and average pore diameter were determined from the N₂ desorption branch using a modified version of the Barrett-Joyner-Halenda (BJH) method which is described in Barrett, E. P., Joyner, L. G., & Halenda, P., The Determination of Pore Volume and Area Distributions in Porous Substances, Journal of the American Chemical Society, 73(7), (1951).

While the films appeared continuous without many defects, the transport of oxygen and moisture depend on the nanoscale structure of the films. Table 4 shows the results of

TABLE 4
Surface area (SBET), total pore volume (Vtotal), micropore
volume (Vmicro) and average pore size (dpore) of xylan-based films
calculated from N₂ gas adsorption isotherms.

| | S BET | V total | V micro | d pore |
|---|---|---|---|---|
| Film | (m2/g) | (cm3/g) | (cm3/g) | (nm) |
| Delignified | 3.1 | 0.0089 | 0.0005 | 14.5 |
| Untreated | 3.1 | 0.0095 | 0.0003 | 15.5 |

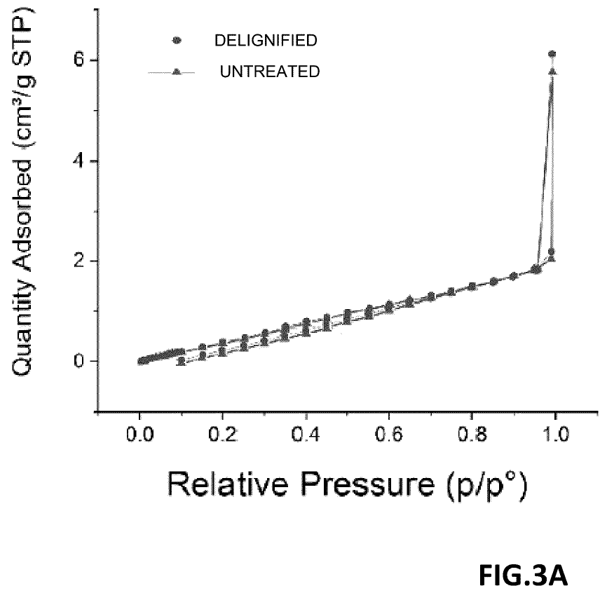

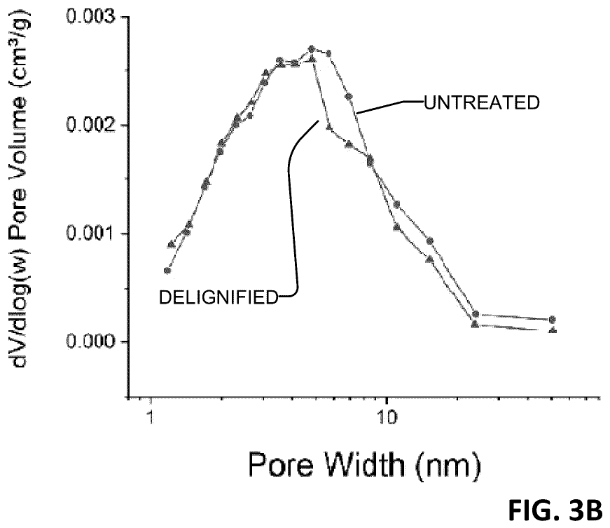

FIG. 3A is a plot showing N₂ adsorption-desorption isotherms for delignified and untreated films. FIG. 3B is a plot of pore size distribution curves of the treated and untreated films calculated using the Barrett, Joyner, and Halenda method.

The N₂ isotherms of the films showed very low adsorption at the low p/p0 pressure range, indicating insignificant volume of micropores (pores having sizes of <2 nm) as calculated by t-plot analysis. The pore size distribution determined by the BJH method showed that both delignified and untreated films had some mesopores having sizes in the range of 1 to 50 nm. Assuming a density of 1.5 g/cm3 for both delignified and untreated films and using the measured pore volume of 0.009 g/cm3, the porosity of both films was found to be 1.3%.

### Tensile Testing

Tensile testing was conducted based on the standard test method ASTM 828-97 using a Q800™ Dynamic Mechanical Analyzer (TA Instruments, USA). Film thickness was approximately 40 microns as measured with a digital caliper. The films were cut into strips approximately 7 mm wide and 25 mm in length. Prior to testing, films were conditioned to 50% RH and 23° C. for 48 hours. Each strip was loaded into the clamps with an initial grip separation distance of 10 mm. A pre-load force of 0.01 N was applied. A Poisson's ratio of 0.04 was used. The force was ramped from 3.00 Newtons per minute to 18.00 Newtons per minute. Tests terminated when the films fractured.

Stress—strain curves were plotted in TA Universal Analysis 2000. Stress, σ, is given by

$$\frac{f o r c e}{a r e a} .$$

Strain, ϵ, is given by

$$\frac{Δlength}{initial length} .$$

The elastic modulus, E, is given by σϵ. Ultimate tensile stress was the maximum stress withstood by the films before fracture. Toughness was the area under the curve (MPa). Modulus of elasticity was taken to be the slope of the initial strain region between 0 and 1%.

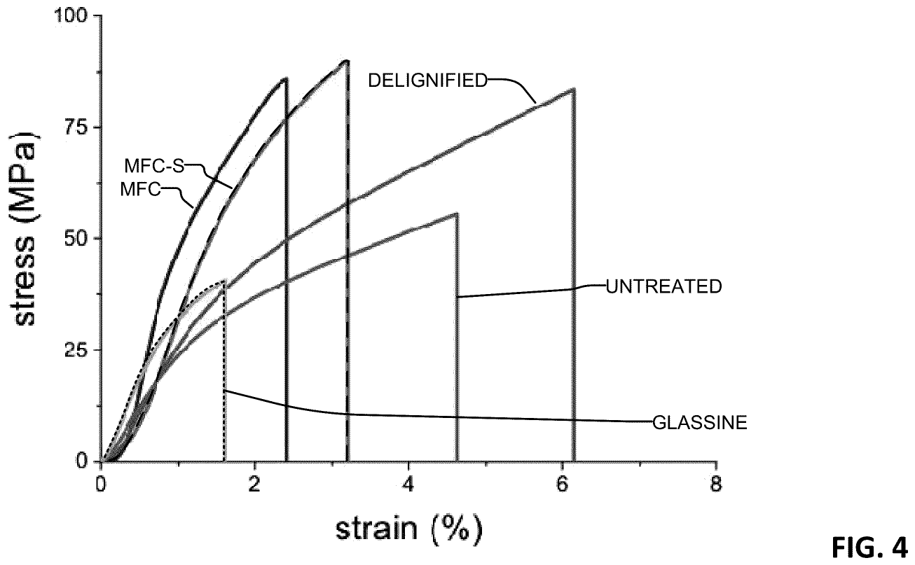

FIG. 4 is a plot that shows stress—strain relationships for delignified films, untreated films, control films made from MFC and MFC with added sorbitol (in a weight ratio (w/w) of MFC:sorbitol of 90:10) and a glassine paper (a commercial and highly purified cellulose specialty paper made by the supercalendering process). Table 5 shows properties of these films. The values in Table 5 are an average of nine technical replicates. All films were equilibrated to 50% relative humidity. Within each column, letters indicate statistically different groups at a P-value of 0.05.

TABLE 5
Mechanical properties of films

| | ultimate | | | |
|---|---|---|---|---|
| | tensile | | | |
| | strength | toughness | Young's | strain at |
| Film | (OUTS, MPa) | (MJ/m3) | modulus (GPa) | break (%) |
| Delignified | 79.36 ± 3.52b | 2.65 ± 0.54a | 3.20 ± 0.23c | 5.57 ± 0.73c |
| Untreated | 54.69 ± 3.25c | 1.71 ± 0.50a | 2.53 ± 0.12d | 4.68 ± 0.92b |
| MFC | 91.31 ± 6.95a | 1.48 ± 0.34a | 4.89 ± 0.56a | 2.98 ± 0.31a |
| MFC-S | 86.11 ± 6.10a | 2.04 ± 0.69a | 6.06 ± 1.30b | 3.75 ± 1.07a, b |
| glassine | 48.50 ± 1.61d | 0.71 ± 0.09b | 3.57 ± 0.47e | 2.18 ± 0.18d |

FIG. 4 shows that the untreated films were more brittle than the delignified films that contain negligible lignin. The untreated films had a strain at break of 5.57% whereas the untreated films had a strain at break of 4.68%. The delignification of xylan was shown to have the effect of not only enhancing the aesthetic appeal of the films, but also improving mechanical properties of the films.

The delignified and untreated films broadly be classified as fibre composites because they contain cellulose fibres embedded in a matrix of xylan and sorbitol. As a matrix material, xylan binds the cellulose reinforcing fibres, transfers loads between fibres, and produces the smooth surface quality of films. Xylan chains can also form oriented fibres which impart mechanical reinforcement to the films. It is likely that the tensile strength of the delignified films could be increased by replacing the MFC with nanofibrillated cellulose (cellulose fibres subjected to a higher level of refinement). A film of nanocellulose has tensile strength much higher than a film of MFC due to higher aspect ratio resulting in better load transfer within the film, higher crystallinity, higher surface area for more interfibrillar bonds, and fewer defects. Anisotropic films of pure nanocellulose can have ultimate tensile stresses as high as 1.13 GPa (Fang et al., 2020), while films of MFC generally have tensile strengths an order of magnitude lower (Spence et al., 2010). MFC may have a cost advantage over other forms of nanocellulose.

### X-Ray Diffraction

Delignified films as described above were prepared by solution-casting and dried at ambient temperature and humidity for 16 hours. Each film was mounted on a cryoloop and analyzed by X-ray diffraction (XRD) at room temperature using a DUO SCXRD instrument in transmission configuration with an APEX II™ CCD area detector (Bruker, USA). Cross-coupled multilayered optics with copper radiation from a IpS microfocus source with a K_{avg} of 1.54184 Å were employed. Four frames were collected at a rate of 180 seconds per frame at a 180-mm detector distance and 360° phi rotation: Frame 1: 2θ=0°, Ω=0°, ϕ=0°, X=0°; Frame 2: 2θ=−16°, Ω=−8°, ϕ=0°, X=0°; Frame 3: 2θ=−32°, Ω=−16°, ϕ=0°, X=0°; and Frame 4: 2θ=−48°, Ω=−24°, ϕ=0°, X=0°. Different spots were chosen by adjusting the translation of the goniometer head. The XRD2Eval program in the Bruker Apex2™ software suite was used to merge the frames together, integrate the data and create a .raw file. X-ray diffraction pattern for the xylan film was plotted in OriginLab™ and the baseline was subtracted using the Asymmetric Least Squares Smoothing tool.

A film of bleached esparto xylan without sorbitol or MFC produced diffraction maxima corresponding to xylan hydrate, at 2θ values of 11.34°, 12.69°, 16.36°, 19.54°, 23.02°, 25.58°, 32.14°, 37.920 and 43.06°. This agrees with other studies on xylan films, with variations in 2θ values within experimental error. In these studies, xylan films were prepared by solution casting, and as the water evaporated the randomly oriented xylan chains aligned to some degree to form crystalline domains within the film. It is expected that preferentially orienting xylan chains would significantly increase its crystallinity and hence tensile strength. This can be done using drawing techniques.

### Water Resistance

Water-resistance of films was improved using paper sizing agent alkyl ketene dimer (AKD) at 0.4% w/w solids loading. When heated, the carbonyl groups on alkyl ketene dimer react with xylan's hydroxyl groups, adding hydrophobic alkyl chains within and on the surface of the film.

Xylan—MFC films were prepared as described above, solution cast and dried at 50° C. overnight. Alkyl ketene dimer or sorbitol were added at solids loadings of 0.4% w/w or 10% w/w, respectively. Films were cured at 70° C. for 5 minutes and then force-cured at 105° C. for 5 minutes.

After these heat treatments, films were equilibrated to ambient temperature and humidity for 48 hours. To estimate the water contact angle, a 15 μL drop of water was pipetted onto the film surface and the droplet on the film was imaged at 0.2 seconds. Two technical replicates were performed for each film. Contact angles were measured using ImageJ™ image processing and analysis software.

Higher contact angles correspond to greater water resistance. Contact angle measurements showed that overall, the hydrophobizing agent AKD created a more hydrophobic film regardless of the presence of plasticizer. However, contact angles decreased over time.

These studies showed that the films with sorbitol and without AKD were the least water resistant, with a water contact angle of 54°. Films without sorbitol and without AKD had a contact angle of 59°. Films containing both AKD and sorbitol had a contact angle of 70°. The most water-resistant films—with a contact angle of 83°—were those without sorbitol and with AKD.

### Water Vapour Permeability

Water vapour permeability of films was determined based on the ASTM E96-15 standard using a PERME® Water Vapor Transmission Rate Test System (model W3/062; Labthink, China). Films were placed on a dish containing distilled water and sealed with a ring gasket. Care was taken to ensure water did not touch the films. Temperature was maintained at 23° C. and the relative humidity outside the cup was 50%. The rate of vapour movement through the films was determined gravimetrically. Three technical replicates were performed. The dishes were weighed every 30 minutes until the water vapour transmission rate was essentially constant over at least six weightings. Water vapour transmission rate (g/h·m2) was calculated according to:

$$W V T R = \frac{G}{t \cdot A}$$

where G is the change in weight in grams, t is the time in hours, and A is the test area.

Table 6 shows the water vapor transmission rate (WVTR) for xylan-based and control films. Three technical replicates were performed for samples of each of delignified film, untreated film and MFC control films with and without sorbitol. One technical replicate was performed for polycarbonate film and coffee packaging.

TABLE 6
Water vapour permeability of films

| Film | Water vapour transmission rate (g/m2 · 24 h) |
|---|---|
| Delignified | 645 ± 8 |
| Untreated | 728 ± 13 |
| MFC | 638 ± 17 |
| polycarbonate | 5.6 |
| coffee packaging | 0.3 |

The water vapour permeability of delignified and untreated films was similar to that of paper which has a typical water vapour transmission rate of approximately 700 g/m²·24 h and was greater than for films of nanocellulose, which typically have water vapour transmission rates of about 250 g/m2·24 h. Hydrophilicity of the samples and the presence of nanoscale pores are likely the cause of the WVTR, which matches that of paper.

Coffee packaging material and a polycarbonate film that was 125 μm thick were included as references. The coffee packaging, a multilaminate material comprising aluminum and polyethylene, had the lowest measured water vapour transmission rate of 0.3 g/m2·24 h. The polycarbonate film was included as a reference and had a WVTR of 5.62 g/m2·24 h

### Water Disintegration Testing

1 cm squares of films, approximately 125 μm thick, were dried to a constant weight. They were placed in glass screw top vials, 20 mL distilled water was added, and the vials were capped. Samples were placed into an incubator with a rotating tube holder (20 cm in diameter). Samples were incubated at 80° C. for 4 days with the rotor set to rotate at 60 rpm. The films were dried to a constant weight and their mass loss determined by subtracting the final weight from the initial weight.

### Biodegradation Testing

The disintegration and biodegradation of delignified films, untreated films and MFC control films was studied in conditions mimicking freshwater, soil, and marine environments. Samples of these films were cut into 1 cm squares which is within the standard range for biodegradation testing of polymer films according to ISO 14855.

Mature compost was obtained from Pacific Coast Renewables Corp (Abbotsford, BC). Mature compost originated from the organic fraction of municipal solid waste. After composting for six weeks at 50° C. 5° C., and subsequently aging for four months, the mature compost was sieved on a screen of 10 mm and used as inoculum for biodegradation experiments.

Films were exposed to aerobic mature compost at mesophilic (25°±5° C.) or thermophilic (50±5° C.) temperatures in a controlled laboratory environment to determine their degree and rate of biodegradation. Biodegradation was measured according to the Standard Test Method for Determining Aerobic Biodegradation of Plastic Materials Under Controlled Composting Conditions Incorporating Thermophilic Temperatures (ASTM D5338-15).

Compost inoculum (500 g) was mixed with distilled water to reach a moisture content of 60% w/w. A series of 2 L reaction vessels fitted with gas sparging were loaded with mixed compost inoculum and test sample (1% w/w). The setup included three replicates of each of the following: a blank that contained inoculum only, a negative control that contained polyethylene cling wrap, a positive control that contained MFC film, and the test samples that included delignified film or untreated film. The films were in 1 cm squares approximately 125 μm thick. Compost vessels were placed into the respirometer device where the temperature was set to either 25° C.±5° C. or 50° C.±5° C. for the duration of the experiment. Each week distilled water was added to the compost mixture to give a final moisture content of 60±5% w/w. Humid air (CO₂ free) was fed to the reactors at a constant flow rate of 500 mL/min. Carbon dioxide was scrubbed by passing input air through two successive 3 M NaOH solutions. Composting vessels were shaken weekly to prevent extensive channeling, maximize contact between inoculum and test material, aerate, and distribute moisture.

For accurate measurement of CO₂, exhaust air was passed over two in-line IR sensors that continuously measured CO₂ concentration. Composting vessels were incubated in the dark for 49 days (mesophilic temperature, 25° C.) or 40 days (thermophilic temperature, 50° C.).

The percentage of biodegradability was the percentage of carbon in the test substance converted to CO₂ during the duration of the test. Total carbon in the test substance was determined prior to the test for all materials by combustion. Carbon dioxide is produced from carbon in the test samples at a stoichiometry of 1:1 (C+O₂→CO₂). Thus, 12 grams of carbon in the test sample theoretically yields 44 grams of carbon dioxide. The amount of CO₂ converted from organic carbon in the test composting vessels was calculated by subtracting CO₂ evolved from blank composting vessels as follows:

$$\% biodegredation = \frac{m e a n {C}_{g} ( test ) - m e a n {C}_{g} ( blank )}{{C}_{i}} \times 100$$

where C_{g} is the gaseous carbon produced and Cᵢ is the initial carbon in the test sample.

Table 7 shows the carbon content and equilibrium moisture contents (at 50% RH) for the films used in the biodegradation testing.

TABLE 7
Carbon content and equilibrium moisture content of films

| | Carbon | Equilibrium moisture |
|---|---|---|
| Film | content (%) | content (%) |
| Delignified | 41.37 | 9.27 |
| Untreated | 41.76 | 9.07 |
| MFC (positive control) | 42.16 | 3.28 |
| Polyethylene (negative control) | 84.86 | 0.00 |

Carbon content was determined by combustion analysis. Each value in Table 7 is an average of two technical replicates.

The carbon contents measured for the negative control, a film of polyethylene (“cling wrap”) having the structural formula (C₂H₄)n and the positive control, MFC which has the structural formula (C₆H₁₀O₅)n, were consistent with the structural formulae. The carbon contents of the delignified and untreated films were lower than the ˜44.5% carbon theoretically expected from a blend of xylan (structure (CSH₈O₄)n), cellulose, sorbitol, and lignin in their respective proportions. It is possible that the remaining ˜3% mass was additional moisture absorbed by the films in the time leading up to the measurements.

### Degradation in Aqueous Environments

Weathering is a preliminary step to biodegradation. Polymers degrade by abiotic factors of physical abrasion, light, pH, and heat and mechanical forces. One experiment tested how the films disintegrate when subjected to the aqueous environment and heat. For this experiment samples of the films were agitated in distilled water at 80° C. for four days.

Before wetting, the delignified film was off-white and semi-transparent, the untreated film was light brown and semi-transparent, and the MFC film appeared opaque and bright white. After the experiment, the samples of the delignified and untreated films were opaque and were both lighter in colour. After the experiment the samples of the MFC film were opaque and bright white except for one of the MFC samples which was semi-transparent after the experiment. The MFC sample may have become semi-transparent as a result of thermo-mechanical erosion of its surface.

After the experiment, the samples of all three types of film were intact. All three film types could be torn with some effort.

The inventors do not wish to be bound to any particular theory, however, the acquired opacity of the delignified and untreated films may have resulted from swelling and change in the refractive index of the material. Possibly water interrupted non-covalent interaction between xylan and cellulose microfibres to cause an increase in the amount of scattered light.

Table 8 shows mass loss of the films in the experiment.

TABLE 8
Disintegration of films after four
days in 80° C. water with agitation

| Film | Mass loss (%) |
|---|---|
| Delignified | 25.02 ± 0.78 |
| Untreated | 29.18 ± 0.74 |
| MFC | 6.58 ± 0.22 |

Mass loss by the MFC film may result from direct loss of loosely attached cellulose fibrils from the surfaces or the edges of the samples. The X-MFC-L-S lost the most mass at 29% w/w during the experiment. Sorbitol, which made up 10% w/w of the xylan-based films, is readily soluble in water and would have dissolved. This loss of volume would then allow the ready transport of materials from the film. Overall, this test highlighted the water sensitivity of the films and at the same time their durability in contact with abiotic factors of water and heat in freshwater ecosystems.

### Aerobic Biodegradation

Another experiment tested the aerobic biodegradation of xylan-based and control films. Biodegradation was assessed based on visual inspection and by CO₂ evolution. In accordance with ASTM D5338, there were three controls: a blank that contained inoculum only, a negative control that contained polyethylene film (“cling wrap”), and a positive control that contained MFC film. By measuring the CO₂ level in the exhaust air every two hours, the amount of CO₂ mineralized from organic carbon in the film samples being tested was calculated.

Fungi and bacteria are key members of the microbial consortia responsible for degrading lignocellulosic biomass in soil or compost at mesophilic temperatures. During biodegradation at 25° C., the microbial filaments growing on delignified films, untreated films and MFC films and throughout the compost may have been fungal hyphae or actinomycete filaments. The film samples discoloured to light brown soon after contacting the mature compost. By week three, all three films were fragmented and easily broken if prodded. The hyphae or filamentous growth was no longer visible on delignified films films after three weeks but could be seen on MFC and untreated films. By week four, the samples of delignified film were indistinguishable from the compost. By week six, the MFC samples and the samples of untreated film were indistinguishable from the compost. These tests suggest that both xylan-based and the pure MFC films are readily biodegradable at mesophilic temperatures.

The polyethylene film samples remained unchanged throughout the experiment. In the blank sample, white fungal hyphae were visible at week one but were not visible for the remainder of the experiment.

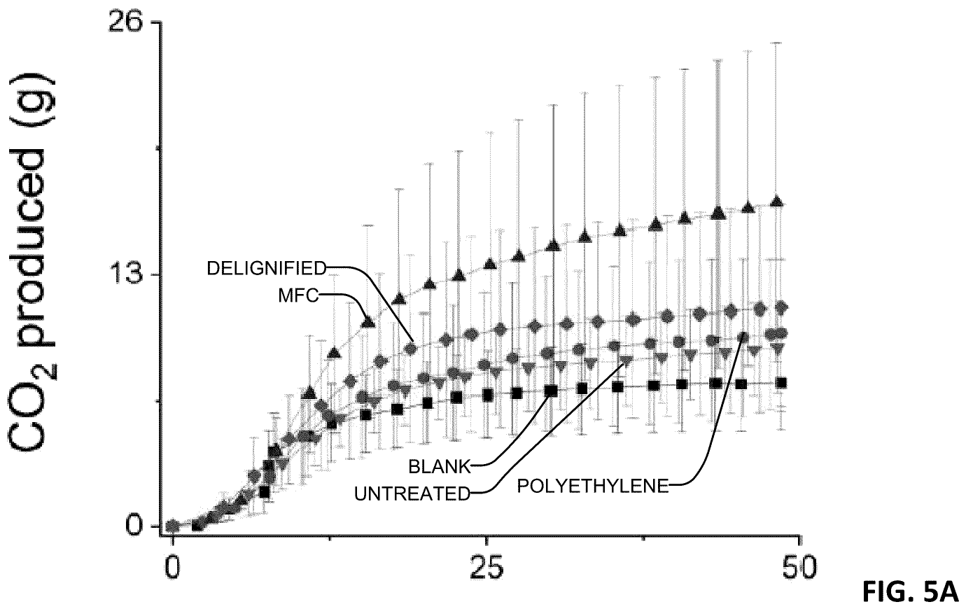

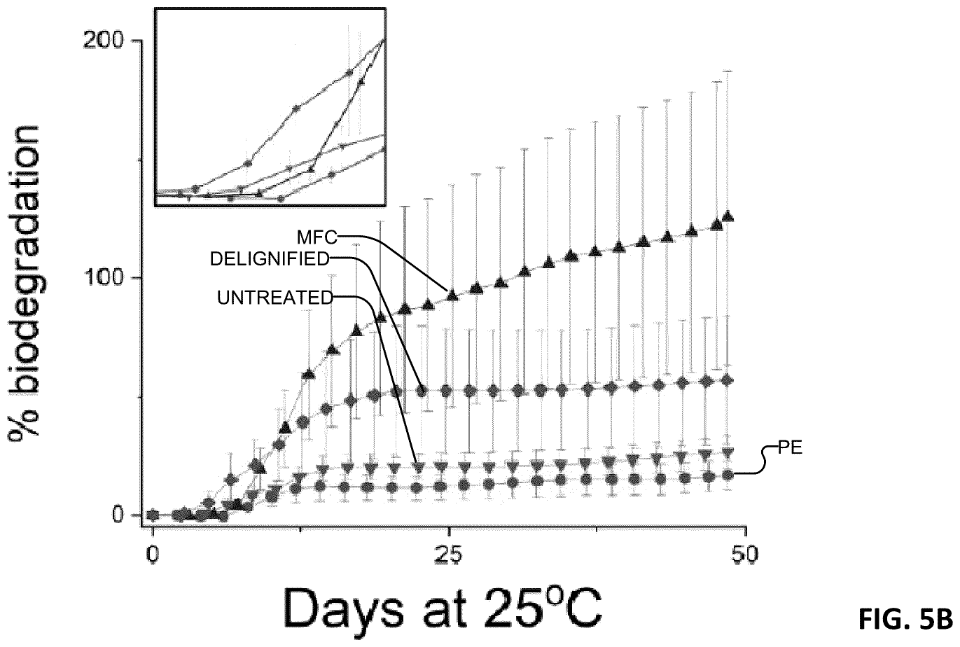

In addition to visible changes, biodegradation of the samples of delignified film was measured by CO₂ production. FIG. 5A is a set of curves that show total cumulative CO₂ production for the samples of different films. FIG. 5B shows % degradation as a function of time for the same films. The inset in FIG. 5B shows biodegradation between days 1 and 10. Three technical replicates were performed per sample. The “blank” vessel contained compost only.

By day four of the experiment vessels containing the delignified film samples had produced the carbon dioxide equivalent of 5% biodegradation. By day 10, the untreated film samples had achieved 50% of maximum biodegradation. By day 20 the delignified film samples plateaued at 52% biodegradation. At day 34 CO₂ slowly started to be released from the vessels containing the delignified film samples.

The positive MFC control showed higher CO₂ production than the delignified samples and did not plateau, reaching 125% biodegradation by day 49.

The standard deviation was 62%, indicating high variability among technical replicates. This is a limitation to biodegradation tests in compost using ASTM 5388, as variations in the organic matter in the compost can cause variations in biodegradation rates and contain different microbial soil consortia.

The fact that biodegradation of MFC exceeded 100% may be explained by invoking the “priming effect”. The priming effect occurs when readily degradable substances act as an energy source for microbial communities, leading to increased microbial activity, degradation of more recalcitrant compounds in soil, and increased CO₂ production. The priming effect was also observed for the delignified and untreated xylan-based films but to a much lesser degree.

Biodegradation of untreated film samples plateaued at 19.6% after 15 days but then showed increased biodegradation up to 26.6% by the end of the experiment. This decreased priming effect (compared to the delignified films) may be related to the fact that microbial consortia specializing in xylan or cellulose breakdown exhibit different metabolisms.

Vessels containing the negative control, polyethylene, which was not visibly degraded during the experiment, surprisingly produced more CO₂ than the vessels containing the blank control during the experiment. This may be related to variations in organic matter in the compost and its associated microbial communities.

The short lag time of xylan-based films compared to the positive control is likely due to the sorbitol included in the delignified and untreated films. Sorbitol is a naturally occurring sugar alcohol that is readily metabolized by microorganisms. Metabolization of sorbitol from the delignified and untreated xylan films may have boosted CO2 production relative to the control films that lacked sorbitol.

The delignified film samples exhibited higher biodegradation than MFC between days three and 11 (inset, FIG. 5B). The untreated films exhibited higher biodegradation than MFC between days one and seven. This is evidence that sorbitol speeds up biodegradation, in addition to improving the mechanical properties of xylan-based films by plasticization.

### Aerobic Biodegradation in Compost at Thermophilic Temperatures

Temperature is a critical factor influencing the activity and composition of microbial consortia during the degradation of natural polymers. As piles of organic matter decay, they heat up to (thermophilic) temperatures of 60° C. or more. The initial microbial population is replaced by one whose physiological adaptations and enzymatic activities are adapted to thermophilic temperatures. To explore differences in biodegradation of xylan-based films by the thermophilic microbial consortium in addition to the mesophilic one, thermophilic biodegradation testing was performed for 40 days using the ASTM D5338 carbon dioxide evolution method.

Each week, test samples were removed from the experimental vessels to visually observe their degradation. During this time both hyphal-like and colony-like growth forms were observed, which could have been fungal hyphae or actinomycete filaments. Hyphae-like growth was visible on samples of both delignified film and untreated film at one week and had disappeared by week two. By three weeks only very small fragments of the delignified film samples were visible. The samples of untreated film were fragmented by week two and had disintegrated by week five. Fungal hyphae were visible on MFC films until week two. After week two, white spots were visible on the films. These spots appeared to be bacterial colonies. The MFC samples decreased in size over the course of the experiment but were still visible (2-3 mm fragments) by week six.

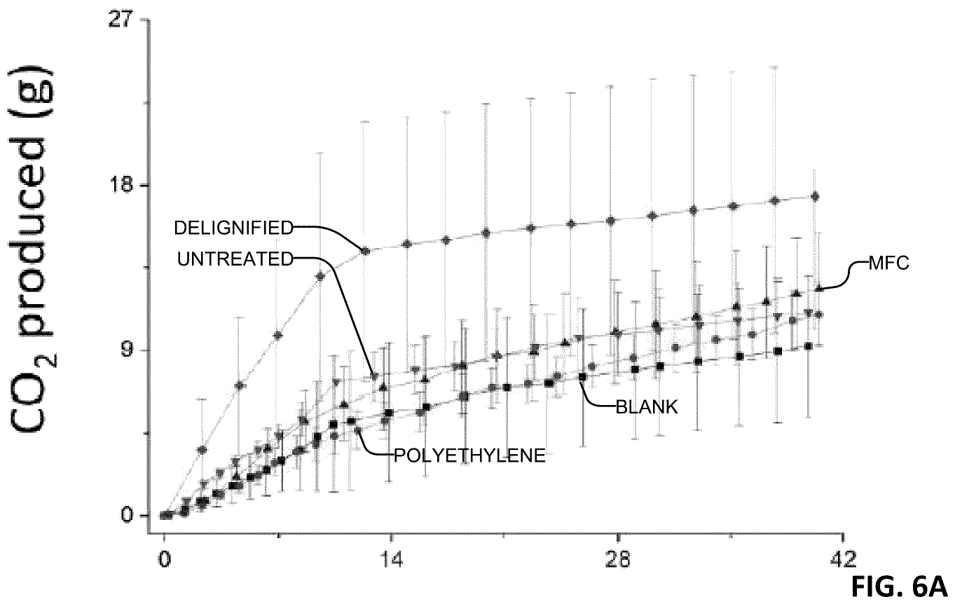

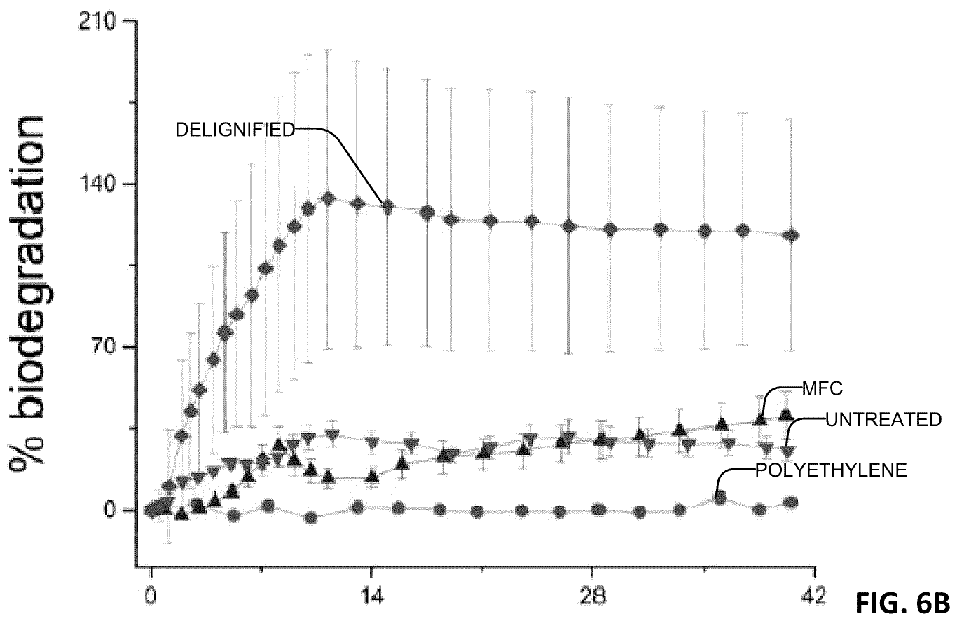

FIG. 6A is a set of curves that show the mass of CO₂ produced by microbial populations as samples of test films were metabolized. FIG. 6B is a set of curves that show % biodegradation of samples of different films as a function of time. The % biodegradation values in FIG. 6B were based on the total carbon content of the films and was obtained by subtracting the carbon dioxide evolved from the blanks. Three technical replicates were performed per sample.

In the first seven days of the experiment, samples of both the delignified film and the untreated film showed significant CO₂ production. For both of these films, biodegradation plateaued after 10 days at 129% and 33%, respectively. There was high variability, 52%, between technical replicates for samples of the delignified film. This variability may be due to differences in the organic matter in the compost or in the microbial consortia.

Samples of MFC control film reached 40.3% biodegradation by the end of the experiment but did not plateau. The negative controls made of polyethylene remained visually unchanged during the experiment. However, these samples produced more CO2 than the blanks, giving an apparent % biodegradation of 3.36%.

FIGS. 6A and 6B show that the delignified film, which contained 30% w/w MFC, biodegraded faster than films made of 100% MFC. Untreated films, which also contained 30% w/w MFC, biodegraded faster than films of MFC until day 31. By the end of the experiment, biodegradation of the untreated films plateaued whereas biodegradation of the MFC control films was still increasing. The faster biodegradation of xylan-based films relative to the cellulose films at both temperatures (25° C. and 50° C.) may arise because the higher crystallinity of cellulose compared to xylan, makes cellulose less readily accessible to microbial enzymes.

Carbohydrates are a primary energy source and are rapidly decomposed upon exposure to microbes. C6 sugars such as glucose and C5 sugars such as xylose feed into glycolysis and the pentose phosphate pathway, respectively. Lignin, due to its phenylpropanoid structure, is highly resistant to biodegradation and can only be degraded by highly specialized peroxidases secreted by ligninolytic or white-rot basidiomycetes. For this reason, rates of mineralization of polysaccharides are higher than rates of mineralization of lignin. This explains why at both thermophilic (50° C.) and mesophilic (25° C.) temperatures, the untreated xylan-based films (which contain significant amounts of lignin) biodegradaded to a lesser degree than the delignified films in the same time period. At mesophilic temperatures, the untreated film samples biodegraded to half the extent of the delignified film samples. At thermophilic temperatures, the untreated film samples biodegraded to one fifth the extent of the delignified film samples

Overall, these tests show that the delignified films and the untreated films are both readily biodegradable under conditions mimicking the home compost (25° C.) and the industrial composting facility (50° C.).

Samples of the delignified film have been tested for biodegradation in seawater. These samples surpassed biodegradation of sodium benzoate (positive control) within 19 weeks.

### Summary of Experimental Results

The foregoing experiments show that delignification improved the aesthetic appeal and mechanical properties of xylan-based films. Both the delignfied films and the lignin-containing untreated films exhibited a stratified ultrastructure and low porosity. The MFC only control films appeared in SEM micrographs to have larger voids.

The delignified films exhibited an ultimate tensile strength of 79 MPa, which was higher than that of the untreated films (55 MPa) and glassine bakery paper (48 MPa). The delignified films had a strain at break of 5.6%. Although the delignified films are inherently hydrophilic, treatment with alkyl ketene dimer improved the water resistance of the delignified films as shown by an increase in contact angle from 54° to 70°. The water vapour transmission rate of the delignified and untreated xylan-based films was relatively high and comparable to that of paper. When exposed to hot water, the delignified film remained intact even after 4 days with mixing.

At the end of its usable life, the delignified film can be put into a home compost or sent to an industrial composting facility, where it will biodegrade within 4 weeks.

The delignified film as described herein is a novel xylan-based film that can be produced at a lower cost than other xylan-nanocellulose fibre composites reported to date. This film is suitable in applications such as: cut-out windows in dry goods packaging, particularly where some breathability is desired; and incorporation into multi-layered packaging. The xylan-based films described herein provide sustainable alternatives to petroleum-based packaging while providing a market for xylan, which is an underused byproduct of the agroforestry industry.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
“where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for making a film, the method comprising:
a. extracting xylan having a molecular weight of at least 22 kDa, from plant based material, the extracted xylan having a a lignin content not exceeding 3% by weight;
b. mixing the extracted xylan with microfibrillated cellulose in a solution;
c. forming a layer of the solution on a surface and drying the solution to form the film on the surface;
d. wherein, between steps a. and b., a solvent content of the extracted xylan is maintained to be at least 50% by weight.

2. The method according to claim 1 wherein, between steps a. and b., the extracted xylan is maintained to have a water content of at least 50% by weight.

3. The method according to claim 1 wherein, upon extraction the extracted xylan has a water content of at least 80% by weight.

4. The method according to claim 1 comprising, between steps a. and b., holding the solution at a temperature in the range of at least 60 C to 90 C for a period of at least 30 minutes.

5. The method according to claim 4 wherein a weight ratio of the extracted xylan to the microfibrillated cellulose is approximately 2:1.

6. The method according to claim 5 wherein a content of glucuronic acid in the xylan does not exceed 7% on a dry weight basis.

7. The method according to claim 1 wherein all or a majority of the plant based material is esparto grass.

8. The method according to claim 7 wherein the esparto grass is of the species Stipa tenacissima, L.

9. The method according claim 1 wherein the solution is a water solution.

10. The method according to claim 9 wherein step b. comprises forming a suspension of the xylan in the solution wherein the suspension has a solids content in the range of about 1% to 3% by weight.

11. The method according to claim 1 wherein step b. comprises providing a plasticizer in the solution.

12. The method according to claim 11 wherein the plasticizer comprises sorbitol.

13. The method according to claim 11 wherein a weight ratio of the extracted xylan to the microfibrillated cellulose to the plasticizer is approximately 6:3:1.

14. The method according to claim 1 wherein the microfibrillated cellulose comprises fibers having a mean length of approximately 20 μm.

15. The method according to claim 1 wherein the microfibrillated cellulose comprises fibers having a ratio of mean length to mean width of at least 40.

16. The method according to claim 1 wherein the film has a tensile strength of at least 60 MPa.

17. The method according to claim 1 wherein the film is translucent or transparent.

18. The method according to claim 1 wherein the film is biodegradable.

19. A film comprising:
a. xylan from plant based material, the xylan having a molecular weight of at least 22 kDa,
a lignin content of 0% to 3% by weight; and
microfibrillated cellulose.

20. The film according to claim 19 wherein the film comprises a plasticizer.

21. The film according to claim 20 wherein the plasticizer comprises sorbitol.

22. The film according to claim 21 wherein a weight ratio of the xylan to the microfibrillated cellulose to the plasticizer in the film is approximately 6:3:1.

23. The film according to claim 19 wherein the xylan is extracted from esparto grass.

24. The film according to claim 23 wherein the esparto grass is of the species Stipa tenacissima, L.

25. The film according to claim 19 wherein the film has a tensile strength of at least 60 MPa.

26. The film according to claim 19 wherein the film is transparent.

27. The film according to claim 19 wherein the film is white in colour.

28. The film according to claim 19 wherein the film has a thickness in the range of 20 μm to 100 μm.

29. The film according to claim 19 wherein the film has a water vapour permeability not exceeding 500 g/m²·24 h.
